(19) United States
(12) Patent Application Publication
(10) Pub. No.: US 2009/0306996 A1
(43) Pub. Date: Dec. 10, 2009

(54) RATING COMPUTATION ON SOCIAL NETWORKS

(75) Inventors: Panayiotis Tsaparas, Palo Alto, CA (US); Krishnaram N. G. Kenthapadi, Mountain View, CA (US); Alan Halverson, Sunnyvale, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/133,370

(22) Filed: Jun. 5, 2008

(51) Int. Cl. G06Q 99/00

(52) U.S. Cl. 705/1

(57) ABSTRACT

A social network may be used to determine a rating of a user with no prior history. The ratings for unrated nodes may be inferred from the existing ratings of users associated with the unrated node in either or both the underlying social network or other social networks. Additionally in some implementations, the effect of the rating of a rated node to an unrated node diminishes as the strength of their relationships decreases. In some cases, a social network may be modeled as an electrical network, and ratings may be modeled as voltages on the nodes of the social network, relationships in the social network may be modeled as connections in the electrical network, and in some cases the strength of relationships may be modeled as conductance of the connections. Ratings for nodes may be determined using Kirchhoff's Law and in some cases by solving a set of linear equations or by propagating positive and negative ratings using a random walk with absorbing states.

### BACKGROUND

A social network is a social structure made of nodes, such as individuals or organizations, which are tied by one or more specific types of interdependency, such as values, ideas, friends, etc. The resulting structures are often very complex. Social network analysis views social relationships in terms of nodes and ties. Nodes are the individual actors within the networks, and ties are the relationships between the actors. A social network is a map of the relevant ties between the nodes being studied.

Social networks have become prevalent in the online world, in the form of instant messaging networks, blogs, forums, content sharing networks, review networks, etc. and are often a part of the online marketplace. For many applications, an estimate of the reputation or rating of a user in the network is useful. The rating of the user may be an indication of a user's reputation. For example, in an online marketplace, a user that is buying an item from another user may find it helpful to know the reputation of the seller. In question and answer systems where users pose and answer questions, it may be useful to know the reputation of the person that answers a question. Reputation estimation is useful in settings where there is a direct transaction between two users. The type of transaction can have many different forms ranging from chatting on an instant messaging network to asking for help or dating.

In such networks, there are usually mechanisms for assigning a rating to the users based on their previous transactions. For example, buyers may rate sellers and answers may be rated by those who pose the question. Users who participate in such a social network eventually build a reputation based on their history. However, for many users, there is little to no history, and as a result there is no way for the social network to estimate their rating or reputation. For example, few people answer questions, and most people have only a small number of transactions. Furthermore, there are some users that are new to the social network, so by default they do not have any rating.

### SUMMARY

A social network may be used to determine a rating of a user with no prior history. Ratings in a social network may be propagated from nodes that have ratings to nodes that do not have ratings. The ratings for unrated nodes may be inferred from the existing ratings of users associated with the unrated node in either or both the underlying social network or other social networks.

In an implementation, the rating of a node depends on the rating of its neighbors (e.g., the average rating of its neighbors), and additionally in some implementations, the effect of the rating of a rated node to an unrated node diminishes as their degree of separation in the network increases.

In an implementation, a social network may be modeled as an electrical network, and ratings may be modeled as voltages on the nodes of the network. Kirchhoff's Law may then be used to determine the unknown voltages, or ratings of nodes in the network.

In an implementation, rating for nodes may be determined by propagating positive and negative ratings using a random walk with absorbing states.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an example of a computing environment in which aspects and embodiments may be potentially exploited;

FIG. 2 is a diagram of an example social network having users;

FIG. 3 is an operational flow of an implementation of a method for determining a rating of a user in a social network;

FIG. 4 is an operational flow of another implementation of a method for determining a rating of a user in a social network;

FIG. 5 is an operational flow of another implementation of a method for determining a rating of a user in a social network; and

FIG. 6 shows an exemplary computing environment.

### DETAILED DESCRIPTION

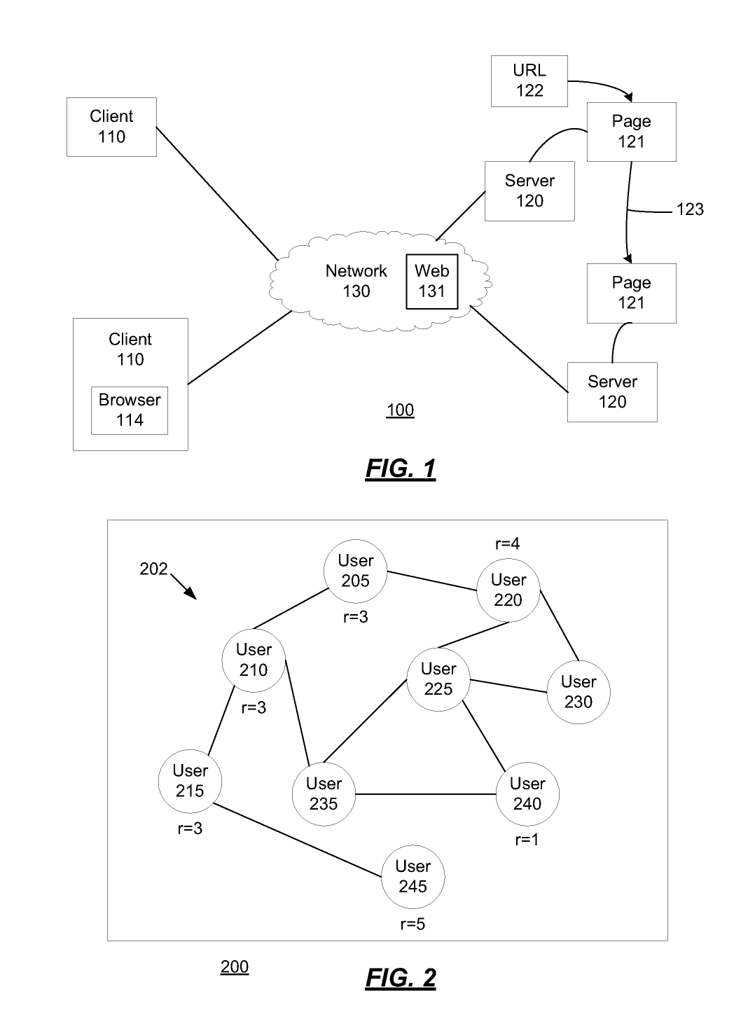

FIG. 1 shows an example of a computing environment 100 in which aspects and embodiments may be potentially exploited. The environment 100 includes one or more client computers 110 (“clients”) and one or more server computers 120 (“servers”) connected to each other by a network 130, for example, the Internet, a wide area network (WAN) or local area network (LAN). The network 130 provides access to services such as the World Wide Web (the “web”) 131. The web 131 allows the client computer(s) 110 to access documents containing text-based or multimedia content contained in, e.g., pages 121 (e.g., web pages or other documents) maintained and served by the server computer(s) 120. Typically, this is done with a web browser application program 114 (a “web browser” or “browser”) executing in the client computer(s) 110. The location of each page 121 may be indicated by an associated uniform resource locator (URL) 122 that is entered into the web browser application program 114 to access the page 121. Many of the pages may include hyperlinks 123 to other pages 121. The hyperlinks may also be in the form of URLs. Content accessed by the client computer(s) 110 may also be dynamically generated, e.g., from a database maintained and served by the server computer(s) 120.

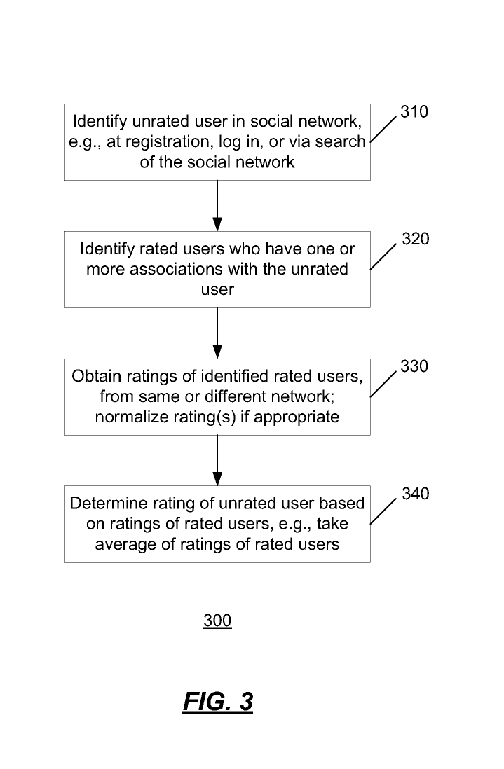

Users may use the client computer(s) 110 to participate in one or more social networks on the web 131. A social network may be hosted by the server computer(s) 120. A social network may be modeled as a graph where each user is a node in the graph, and the relationships between two users is modeled as an edge in the graph. FIG. 2 is a diagram of an example social network 200 having users 205-245. The social network 200 is modeled as a graph 202 where the users 205-245 are represented as nodes.

A user may have a rating that is indicative of that user's reputation in the social network such as social network 200 of FIG. 2. Some of the nodes in the graph 202 may already have a rating r that corresponds to the user's reputation in the social network 200. For example, users 205, 210, and 215 may each have a rating of 3, user 220 may have a rating of 4, user 240 may have a rating of 1, and user 245 may have a rating of 5. Any rating system may be used, such as a numerical rating that is between a range, e.g., of 0 to 5, −5 to +5, 0 to 100, a star rating, a letter rating, or any other appropriate rating. In the illustrated example of FIG. 2, the nodes corresponding to users 205, 210, 215, 220, 240, and 245 are rated nodes.

Other users in the social network may be unrated, which may be modeled as unrated nodes in the example graph 202 of FIG. 2, such as the nodes corresponding to users 225, 230, and 235. The social network may be used to infer a rating of an unrated user. As described further herein, given some users on the social network for whom a rating is known (e.g., the rated nodes in the social network), a rating for the remaining nodes (the unrated nodes) may be determined. For the unrated nodes in the graph 202, an estimate of their rating may be based on the rating of users in the social network with whom they have a relationship. The relationships used to estimate the rating may be any number or combination of relationships, e.g., direct neighbors, secondary relationships with a degree of separation, relationships within other social networks, etc. Accordingly, ratings, and hence reputation, may be propagated on a social network.

For a rating propagation technique, the rating of a user (positive or negative) is propagated through the network. For example, for users that have no rating, their ratings may be estimated based, at least in part, on the rating of user with whom they have a relationship, such as their friends and their friends' friends. That is, if two users have a relationship and one of them is highly rated then some of the positive rating may be passed on to the unrated user. In a further implementation, the stronger the relationship between the two users, the higher the correlation or influence on the rating of the unrated user. Thus, if a close relationship with a user has a high (or low) rating then the higher (or lower) the rating of the unrated user. Similarly, the propagation of ratings between two users may decrease in correlation or effect as their relationship decreases, which may be visualized by an increase in distance between the users on a social network graph. Correlating ratings between users with relationships and basing the strength of the correlation on the strength of the relationship model the real world maxim where the reputation of individuals in a social network may be influenced by the friends that they have.

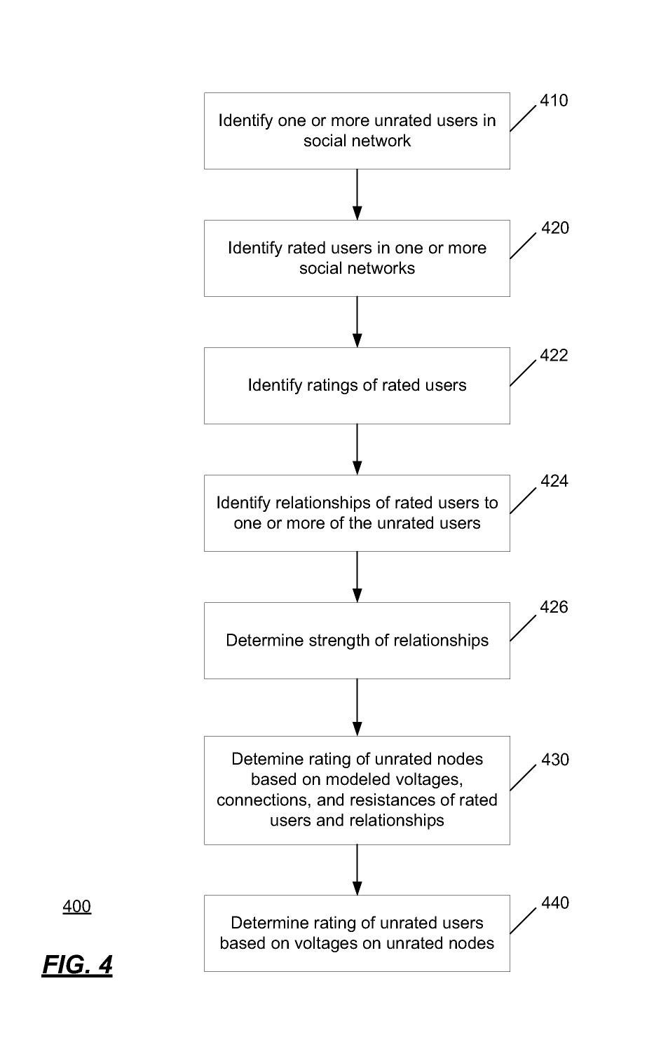

FIG. 3 is an operational flow of an implementation of a method 300 for determining a rating of a user in a social network. At 310, an unrated user in a social network may be identified. In an implementation, an unrated user may be identified when the user registers with the social network or logs in to the social network. Alternatively or additionally, a search of the social network for unrated users may be performed from time to time, periodically, and/or at predetermined times (e.g., every day at midnight, once a week, etc.).

Rated users (i.e., users with ratings) who have one or more associations with the unrated user may be identified at 320. The associations may be based on any association which may be predetermined in type (friendship, family, common interest(s), same network, etc.), number, and/or strength (direct relationship, predetermined degree of separation, etc.), etc. For example the strongest five relationships of an unrated user with rated users may be identified. In another example, all the relationships of a particular type and/or strength may be used. The rated nodes and/or relationship with the unrated node may be within the same social network as the unrated node and/or may includes nodes (ratings and/or relationships) from social networks other than the unrated node (e.g., the user associated with the unrated node may have ratings and relationships with rated users in other social networks). In an implementation, the unrated user may identify rated users and/or social networks that are associated with the unrated user. These user provided rated users and/or social networks may be used at least in part to identify rated users of operation 320 or alternatively, the user identified users may be ignored and other rated users associated with the unrated user may be identified. To identify rated user associated with the unrated user, information provided by or about the unrated user may be used to identify rated users having an association with the unrated user. Associated rated users may be identified from the social network itself, or may be identified from other networks or platforms. For example, a first social network may be directed to blogging and may be searched for rated users adding comments to the unrated user's blog (or similarly the unrated user adding comments to a rated user's blog). A second social network (e.g., directed to dating) may be used to identify associations the unrated user has with rated users, such as past communications between rated users and the unrated user, which in some embodiments may be communications from a rated user to the unrated user. Any appropriate method may be used to determine relationships to the unrated user in one or more social networks of any type. These relationships may then be examined to determine if any of those relationships are with a rated user. Such identifications and/or associations in the first social network and the second social network may be considered in a third social network where the user in unrated. Thus, the associations of users in one network may be transferred to another network.

The ratings of the identified rated users may be obtained at 330. The ratings may be retrieved from storage associated with the social network. In an implementation, the ratings may be imported or otherwise received from one or more other networks or platforms. For example, an unrated user in a first social network (e.g., a blogging social network, an instant messaging network, etc.) may be associated with a rated user on a second social network (e.g., a dating social network, a question and answer platform, a marketplace network, etc.). The rating (or ratings) for an identified rated user that is associated with the unrated user may be received from the second network (which may be the same as the first network or different, and may include one or more other networks) and associated with the identified rated user as an input to the unrated user's rating (or ratings) on the first social network.

The rating(s) received from networks or platforms outside the social network may be translated in any appropriate manner e.g., normalized or otherwise scaled, to fit a rating range or scheme used by the social network where the user is unrated. In an implementation, one or more ratings from networks or platforms outside the social network may be combined or otherwise factored in with ratings from the social network to provide an aggregated rating for a rated user on the social network. For example, if a rated user has a relationship with the user in more than one social network, those ratings of the multiple social networks may be aggregated in any appropriate manner (e.g., averaged, weighted on relationship strength, activity in the network, etc.) and considered as a single aggregate rating.

At 340, a rating of the unrated user on the social network may be determined based on the ratings of the identified rated users (i.e., the rated users who have an association with the unrated user) using any appropriate algorithm or technique. The rating of the unrated user may be determined in any suitable manner considering the ratings of rated users having a relationship to the unrated user. For example, in an implementation, the rating of the unrated user may be determined based on the average of the ratings of the rated users having an association with the unrated user. In another implementation, the strength of the relationships between the unrated user and the rated users may be considered and the ratings may be weighted accordingly in the determination of the rating of the unrated user. For example, a stronger weight may be given to the ratings of users who have a close or strong or other predetermined relationship with the unrated user (e.g., an association within a blogging social network may be given a higher weight than a weight than a buyer/seller relationship in a marketplace social network). The stronger weight means that the ratings of these rated users will be propagated more strongly to the determined rating of the unrated user. Similarly, in an implementation, the propagation of ratings between two users may decrease as the proximity or strength of their relationship decreases. It is to be appreciated in some weighting schemes that a higher weight may be used for strong relationships where the rating system indicates a high rating with a ‘good’ rating, and conversely, a lower weight may be given for stronger relationships to reflect a rating scheme where ‘good’ ratings have a lower numerical value than a ‘bad’ rating.

In an implementation, the graph of the social network of users may be analogized as an ‘electrical network’ where the edges (user relationships) of the graph correspond to wires that carry current between the nodes (users), and the ratings on the rated nodes correspond to voltages in the ‘electrical network’. In implementations that consider the strength of the relationship, the strength of the relationship may correspond to the conductance (or inverse of the resistance) between nodes in the ‘electrical network’. In one implementation, Kirchhoff's Law may be used to estimate the voltages or ratings of the unrated nodes. FIG. 4 is an operational flow of another implementation of a method 400 for determining a rating of a user in a social network using the analogy of a social network and an electrical network.

At 410, one or more unrated users may be identified in a social network in a manner similar to that of operation 310 of FIG. 3. At 420, rated users in one or more social networks may be identified in a manner similar to of operation 320 of FIG. 3. At 422, the ratings of the rated users may be identified. At 424, the relationships of the rated users to one or more of the unrated users may be identified. At 426, the strength of the relationships may be determined.

The strength or proximity of relationships may be ignored in some cases. In that implementation, each edge (relationship) between two nodes has unit resistance where the strength of the relationship is not considered or the relationships have the same strength. Alternatively, the strength or proximity of the relationships may be considered. In the electrical network analogy, this may be implemented by the edges or relationships having different resistances where the resistance between the user nodes is the inverse of the strength or proximity of the relationships between users corresponding to the nodes.

At 430, the ratings of the unrated nodes may be determined based on the modeled voltages, connections, and resistances of the rated users and relationships in the social network. Any suitable technique or algorithm may be used. For example, the voltage at an unrated node (i.e., the rating at an unrated node) may be determined to be equal to the average rating of all of its neighbors. At 440, the rating of an unrated node, and thus the user corresponding to the node, may be based on the determined voltage of the node. This may include translating the determined numerical voltage into the rating system of the social network. Thus, the rating of the unrated user may be determined based on an analysis of the electrical network.

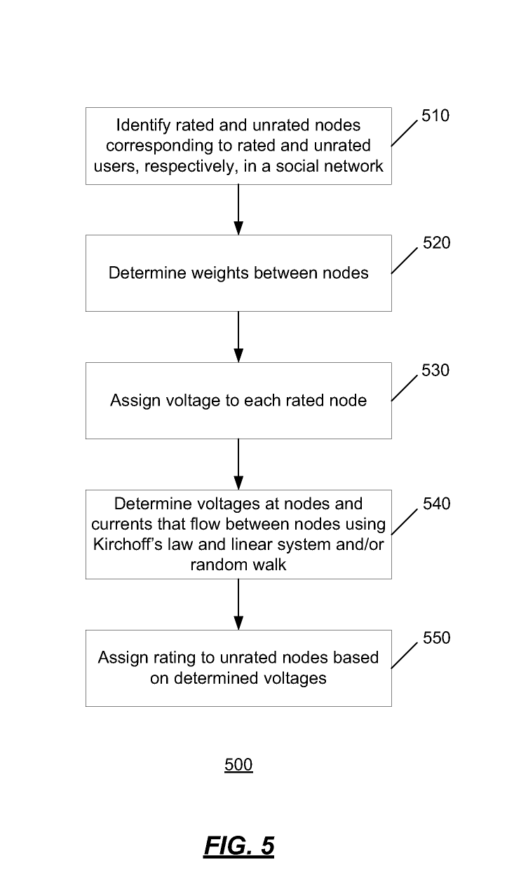

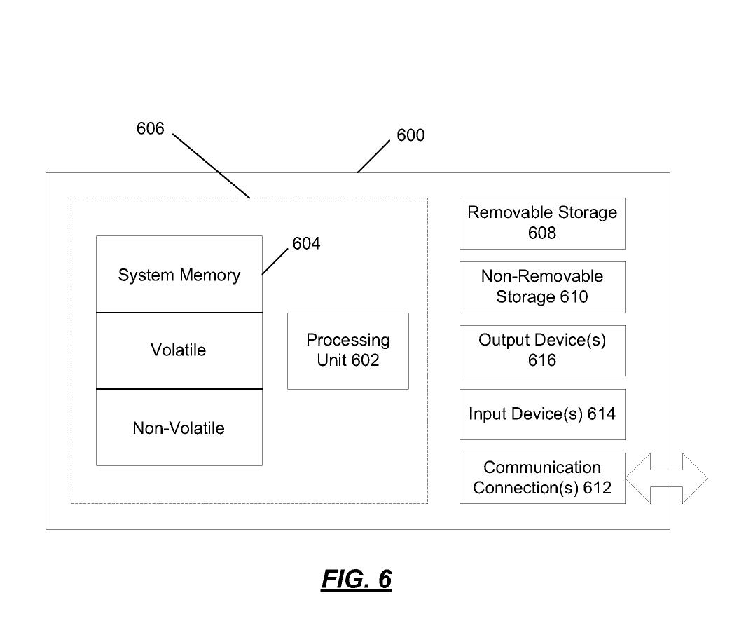

In an implementation, using Kirchhoff's law, the voltages and thus the ratings of the unrated nodes may be determined. FIG. 5 is an operational flow of another implementation of a method 500 for determining a rating of a user in a social network considering the strength or proximity of the relationships between rated and unrated users and using Kirchhoff's Law.

A social network may be represented by a weighted, undirected graph G, which in turn may be represented by a matrix (V,E) of nodes having a rating represented by a voltage V at the node and the relationships (and optionally their strengths) represented by the edges E between the nodes. At 510, rated and unrated nodes corresponding to rated users and unrated users, respectively, may be identified in a social network. At 520, weights between nodes may be determined. The weights C(i,j) between two nodes i and j capture the strength of their relationship and may be determined in any appropriate manner. For example, the strength of the relationship may consider the degree of separation between the nodes i, j, the frequency of communication between the users represented by the nodes i, j, etc.

A subset of users having a rating may be denoted by R, and a set of unrated nodes may be denoted by ∪. Let m be the size of R and let n be the size of ∪. Let rᵢ denote the rating of node iεR (taking values within an interval [−k,+k]), and let uᵢ denote the assigned rating to node iε∪. The ratings uᵢ may be determined using electrical network theory.

At 530, to each of the rated nodes j, a voltage of value rⱼ may be assigned. An edge (i,j) can be thought of as an electrical wire with conductance C(i,j). Using Kirchoff's law, the voltages at all nodes in the network may be determined at 540 along with the currents that flow between the nodes in the network. As described further herein, any appropriate technique or algorithm may be used such as a linear system (described further below) and/or a random walk technique (discussed further below). For each unrated node, a voltage may be determined and may be used to assign a rating to that node at 550.

Kirchhoff's law gives a characterization of how to compute the voltages on each node. If I(x,y) is the current on edge (x,y) and V(x) is the voltage on node x, then for each edge (x,y),

I(x,y)=C(x,y)((V(y)−V(x)) Equation (1)

and for each node xε∪, current into the node equals current out of the node, or

$${\sum }_{y \text{:} ( x , y ) ∈ E} I ( x , y ) = 0. \qquad Equation ( 2 )$$

From Equations (1) and (2), a linear system for the computation of voltages may be obtained. For each node xε∪,

$$V ( x ) = {\sum }_{y \text{:} ( x , y ) ∈ E}^{ } \frac{C ( x , y )}{C ( x )} V ( y ) \qquad Equation ( 3 )$$

where

$$C ( x ) = {\sum }_{y \text{:} ( x , y ) ∈ E}^{ } C ( x , y ) ,$$

a normalization factor.

Solving this linear system gives the voltage values. Note that according to Equation (3), the rating of an unrated node is the weighted average of the ratings of all its neighbors. Thus, a linear equation may be obtained for every node. Solving the linear equations can be expensive.

In an implementation, a random walk technique may be used to determine voltages at the unrated nodes. Absorbing random walks may be used with the property that the nodes with ratings are considered absorbing states. When one of these nodes is reached during the random walk, the random walk stops. Consider a random walk that starts at the unrated node i and randomly follows edges in the network, where the probability of going from node x to node y is proportional to the conductance C(x,y). When the random walk reaches one of the rated nodes then it is absorbed, i.e., it does not escape from that state.

Thus, the process of determining voltages may be similar to performing a random walk on the representation of the graph, where the rated nodes correspond to absorbing states. For each unrated node x, the probability that the random walk that starts from x is absorbed at some rated node y may be determined. Then node x receives a “benefit” equal to the rating of node y, with that probability. The rating of x is the expected benefit it receives. Computing the probability of x landing at y can be done efficiently.

As described further below, using matrix operations, an n×m probability matrix P may be determined, where P(i,j) is the probability that a random walk that starts at node i is absorbed at node j. When reaching the absorbing node j, node i may receive a benefit of value rⱼ (the “benefit” may be negative). Then the voltage at node i is equal to the expected benefit at node i. Intuitively, a node that is close to many nodes with high rating will also receive a high rating, while a node close to nodes with low rating will receive a low rating.

More particularly, let M be the transition matrix of the random walk. Without loss of generality, assume that the nodes 1, . . . , m are the nodes in R, and the nodes m+1, . . . , n+m are the unrated nodes in ∪. A transition matrix may be generated that represents the probability of a transition from a node i to a node j. The transition matrix may be given by

$$M = [ \begin{matrix}I & 0 \\ A & Q\end{matrix} ] . \qquad Equation ( 4 )$$

Matrix A may be an n×m matrix (m nodes have ratings, n nodes do not have ratings) that captures the probability that there is a direct transition from a regular (non-absorbing) state (unrated node) to an absorbing state (rated node). Matrix Q may be an n×n matrix that is a transition matrix for moves between the regular nodes (the probability of a jump from a non-absorbing state to another non-absorbing state). Matrix I is an identity matrix corresponding to absorbing states. 0 is provided because there is no jump from an absorbing state to a non-absorbing state. A probability P(i,j) may be determined that a walk that starts from unrated node i will end up at rated node j. That is, an n×m matrix P may be computed that stores P(i,j), where P is the probability of going from an unrated node to a rated node.

If the random walk performs exactly one step then the probability matrix would be A. For two steps, the probability matrix is QA, and for k steps it is Q^{k-1}A. Therefore, the matrix P may be determined as

P=A+QA+Q²A+ . . . +Q^{k}A+ . . . . Equation (5)

where the sum is taken over infinity. This may be computed as

P=(1−Q)⁻¹A. Equation (6)

Computing the inverse of a matrix may be a computationally expensive operation. The computation may be speeded up by observing that the end result that may be used is an n×m matrix rather than an n×n matrix. Using Equation (5), successive n×m matrices may be determined that may be added up to determine P. This means that only n×m weights may be maintained, which can be updated by Equation (7) below. If P^{t}(i,j) is the determined probability at iteration t of unrated node i to be absorbed at the rated node j, then

$${P}^{t} ( i , j ) = {\sum }_{y \text{:} ( x , y ) ∈ E} \frac{C ( x , y )}{C ( x )} {P}^{t - 1} ( i , j ) . \qquad Equation ( 7 )$$

These equations may be iterated until the probabilities converge.

Furthermore, if there are l distinct weights, an n×l matrix may be determined. The nodes with the same rating may be combined into a single absorbing state. The probability for a non-rated node to reach that state may be determined. The expected benefit of the node will be the same as in the case that each rated node is a separate absorbing state.

In an implementation, the determined ratings for unrated nodes may be in the same range as that of the given ratings. For example, if all nodes in R have a rating between −5 and 5, the derived ratings will also be in that range. This is because every derived rating is an expectation of given ratings and hence cannot lie outside the original range. Additionally, the ratings of the rated nodes in R are not affected by the process. That is, the rated nodes retain their rating.

A sink node may be used to avoid a situation on a network having only a single rated node in which any random walk would always be absorbed at the single rated node. As a result, in such a situation, all nodes would receive the same rating regardless of their distance to the rated node. In an implementation, a sink node s having zero voltage may be used. For each of the unrated nodes iε∪, assume that there is a wire that grounds the node to the sink node. The conductance of the wire is α, and it is the same for all unranked nodes in the network. Adding the sink node has the effect that some of the current that reaches node i is directed towards the sink node, and as a result the voltage of the nodes decreases as the distance to the rated node increases.

In an implementation, the derived ratings do not induce “feedback” and could have been in the set of rated nodes without affecting any of the derived ratings or original ratings. Suppose the rating for a node x in ∪ is determined to be uₓ. If the technique is rerun with R∪x as the set of nodes with given ratings, the determined ratings for other unrated nodes would still be the same. This is because, viewed as an electric network, the currents and voltages do not change if a node x is connected to a source with voltage uₓ (as the potential at x is already uₓ). Additionally, the rating for a node x depends only on those nodes in R which are reachable from x in the absorbing Markov chain. This property may be useful in certain contexts and not useful in other contexts.

FIG. 6 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by device 600 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for determining a first rating of a first unrated user in a first social network, comprising:
identifying the first unrated user in the first social network;
identifying a second rated user having a relationship to the first unrated user in a second social network;
identifying the second rating of the second rated user; and
based at least in part on the second rating, determining the first rating in the first social network of the first unrated user.

2. The method of claim 1, wherein the second social network is a different social network than the first social network, the method further comprising translating the second rating in the second social network to a rating scale of the first social network.

3. The method of claim 2, further comprising receiving an indication of the second social network from the first unrated user, and wherein identifying the second rated user and the second rating of the second rated user includes identifying the second rated user and the second rating in the second network based on the indication of the second social network.

4. The method of claim 1, wherein identifying a second rated user includes identifying a plurality of rated users, wherein identifying the second rating includes identifying a rating for each of the plurality of rated users, and determining the first rating includes determining the first rating in the first social network of the first unrated user based at least in part on the rating for each of the plurality of users.

5. The method of claim 4, wherein identifying the rating of each of the plurality of users comprises identifying a third rating of a third user of the plurality of users from a network different from the first social network.

6. The method of claim 5, further comprising translating the third rating from the network different from the first social network to a rating scale of the first social network.

7. The method of claim 5, wherein identifying the third rating includes identifying a fourth rating of the third user in a fourth network and identifying a fifth rating of the third user in a fifth network different from the fourth network, and aggregating the fourth rating and the fifth rating into the third rating.

8. The method of claim 1, further comprising determining a strength of the relationship, and wherein determining the first rating includes determining the first rating in the first social network of the first unrated user based at least in part on the second rating and the strength of the relationship.

9. The method of claim 8, wherein determining the first rating includes using Kirchhoff's Law to determine an unknown voltage by corresponding the second rating to a known voltage in an electrical network, corresponding the first rating to the unknown voltage in the electrical network, corresponding the strength of the relationship to a conductance between the known voltage and the unknown voltage.

10. The method of claim 9, wherein using Kirchhoff's Law to determine the unknown voltage includes solving a set of linear equations.

11. The method of claim 9, wherein using Kirchhoff's Law to determine the unknown voltage includes using a random walk to determine the unknown voltage.

12. The method of claim 1, wherein the second social network is the first social network.

13. One or more computer readable storage media containing computer readable instructions that, when implemented, perform a method comprising:
identifying one or more unrated users in a first social network;
identifying one or more rated users having one or more relationships to the one or more unrated users in a second network;
identifying the rating of the one or more rated users in the second network;
determining a strength of each of the one or more relationships; and
determining the rating of the one or more users in the first social network based at least in part on the rating of the one or more rated users in the second network and the strength of each of the one or more relationships.

14. The computer readable storage media of claim 13, further comprising:
corresponding the rating of the one or more users in the first social network with unknown voltages in an electrical network;
corresponding the rating of the one or more rated users in the second network with known voltages in the electrical network;
corresponding the one or more relationships with electrical connections in the electrical network;
corresponding the strength of each of the one or more relationships with a conductance of the electrical connections; and
wherein determining the rating of the one or more users in the first social network includes determining the unknown voltages in the electrical network using Kirchhoff's Law.

15. The computer readable storage medium of claim 14, wherein one or more rated users having one or more relationships to the one or more unrated users includes identifying a first rated user and having a first rating in the first network and identifying a second rated user having a second rating in the second network, the second network being different from the first social network, and wherein determining the rating of the one or more users in the first social network includes determining the rating of the one or more users in the first social network based at least in part on the first rating and the second rating.

16. The computer readable storage medium of claim 15, wherein identifying one or more unrated users in the first social network includes identifying a first unrated user and a second unrated user in the first social network; wherein determining a strength of each of the one or more relationships includes determining a first relationship strength of a relationship between the first rated user and the first unrated user, determining a second relationship strength of a relationship between the second rated user and the second unrated user; and wherein determining the rating of the one or more users in the first social network includes determining a third rating of the first unrated user based at least in part on the first rating and the first relationship strength and determining a fourth rating of the second unrated user based at least in part on the second rating and the second relationship strength.

17. A method for determining a rating of a user in a social network, comprising:
identifying an unrated node in a representation of a graph comprising a plurality of nodes;
identifying a plurality of rated nodes in the representation of the graph;
assigning a voltage to each of the rated nodes based on a rating of the associated node of the rated nodes in the social network; and
assigning a rating to the unrated node based on the voltages of the rated nodes.

18. The method of claim 17, further comprising determining a weight between each of the nodes in the representation of the graph, determining a plurality of currents between the nodes based on the weights, wherein assigning the rating to the unrated node is further based on the currents between the nodes.

19. The method of claim 17, wherein assigning a rating to the unrated node comprises solving a linear system in Kirchhoff's Law for unknown voltages of the unrated nodes, and translating the unknown voltages of the unrated nodes to the rating of the unrated nodes.

20. The method of claim 17, wherein assigning a rating to the unrated node comprises using a random walk through the rated nodes to the unrated nodes and Kirchhoff's Law to determine a voltage for each of the unrated nodes, and translating the determined voltages to the rating of the unrated nodes in the social network.
